(19) United States
(12) Patent Application Publication
(10) Pub. No.: US 2020/0164431 A1
(43) Pub. Date: May 28, 2020

(54) METHODS FOR MANUFACTURING CAST COMPONENTS WITH INTEGRAL THERMAL BARRIER COATINGS

(71) Applicant: GM GLOBAL TECHNOLOGY OPERATIONS LLC, DETROIT, MI (US)

(72) Inventors: Michael J. Walker, Shelby Township, MI (US); Paul M. Najt, Bloomfield Hills, MI (US); Russell P. Durrett, BLOOMFIELD HILLS, MI (US)

(21) Appl. No.: 16/202,705

(22) Filed: Nov. 28, 2018

(51) Int. Cl. B22D 19/08; F02B 77/02; F01N 13/10; F02F 1/00; F02M 35/104; F01N 13/14; F02M 35/10; F01N 13/18

(52) U.S. Cl. CPC B22D 19/08; F02B 77/02; F01N 13/102; F02F 1/004; F02F 2200/06; F01N 13/14; F02M 35/10347; F01N 13/1861; F02M 35/104

(57) ABSTRACT

A method for applying a thermal barrier coating (TBC) to a surface of a cast component includes providing a core, applying the TBC to the core to form a coated core, disposing the coated core within a casting mold, casting metal around at least a portion of the coated core to form a casting intermediary, and removing the core from the casting intermediary to form a cast component. The TBC includes hollow microspheres comprising metal, glass, and/or ceramic materials. The hollow microspheres can have an average diameter of about 10 μm to about 100 μm. The component can be an automotive component, such as an engine intake assembly, an engine exhaust manifold, an engine block, and/or an engine cylinder head. The surface of the cast component can be one or more surfaces which define an engine intake passage, an engine exhaust passage, and an engine combustion chamber.

### BACKGROUND

Some vehicles include an engine assembly for propulsion. The engine assembly can include an internal combustion engine and a fuel injection system. The internal combustion engine includes one or more cylinders. Each cylinder defines a combustion chamber. During operation, the internal combustion engine combusts an air/fuel mixture in the combustion chamber in order to move a piston disposed in the cylinder.

Maintaining temperature environments in engine assemblies can be limited based upon the configuration of the engine assembly and the functions of various components. Uneven temperature distributions can affect the efficiency of components. In internal combustion engines, coatings insulate the hot combustion gas from the cold, water-cooled engine block, to avoid energy loss by transferring heat from the combustion gas to the cooling water. Further, during the intake cycle, the coatings should cool down rapidly in order to not heat up the fuel-air mixture before ignition.

### SUMMARY

A method for manufacturing a cast component having a surface with a thermal barrier coating (TBC) applied thereto is provided. The method includes providing a core, applying the TBC to the core to form a coated core, disposing the coated core within a casting mold, casting metal around at least a portion of the coated core to form a casting intermediary, and removing the core from the casting intermediary to form a cast component. The TBC can include a plurality of hollow microspheres. The method can further include removing the casting intermediary from the casting mold. The TBC can be applied to the core such one or more regions of the core remains exposed. The coated core can be disposed within the casting mold such that at least a portion of each of the one or more exposed regions of the core are not covered with cast metal. The core can include a binder and one or more fillers. The binder can be a silicate-based material, and the core can be removed mechanically. The core can be a salt-based material, and the core can be removed via water. The hollow microspheres have an average diameter of about 10 μm to about 100 μm. The TBC has a porosity of at least about 75%. The hollow microspheres can include a metal, glass, and/or ceramic material. The hollow microspheres can have a shell thickness of about 2% to about 10% of the diameter of the microsphere. The core can further include an outer metal layer. Applying the TBC to the core further can further include sintering or otherwise solidifying the TBC. The TBC can further include a binder, and applying the TBC to the core can include applying the TBC directly to the core. Applying the TBC to the core can further include curing the TBC.

A method for manufacturing a cast automotive component having an internal passage with a thermal barrier coating (TBC) applied to a surface thereof is provided. The method includes providing a core, applying the TBC to the core to form a coated core, disposing the coated core within a casting mold, casting metal around at least a portion of the coated core to form a casting intermediary, and removing the core from the casting intermediary to form a cast component. The TBC can include a plurality of hollow microspheres. The automotive component can be an engine intake assembly, an engine exhaust manifold, an engine block, and/or an engine cylinder head. The surface of the cast automotive component can be one or more surfaces which define an engine intake passage, an engine exhaust passage, and an engine combustion chamber.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a cross-section of a vehicle illustrating a side view of a single cylinder internal combustion engine having a thermal barrier coating disposed on one or more components, according to one or more embodiments;

FIG. 2 illustrates a schematic cross-sectional side view of a thermal barrier coating disposed on a component, according to one or more embodiments; and

FIG. 3 illustrates a flow diagram of a method for manufacturing a cast component having a surface with a thermal barrier coating (TBC) applied thereto, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

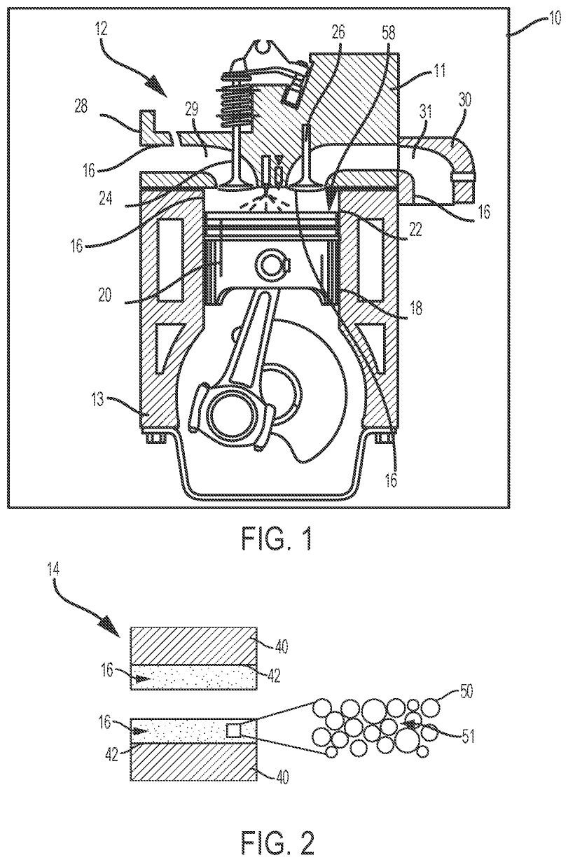

Provided herein are methods for manufacturing cast components with integral thermal barrier coatings (TBC). Such methods will be described in reference to automotive components, such as diesel or gasoline internal combustion engines (ICE), for the purpose of illustration only and one of skill in the art will readily determine that the disclosed methods are generally suitable for any cast component having integral TBCs. FIG. 1 illustrates a portion of a vehicle 10 comprising an ICE 12. The vehicle 10 can include any motorized vehicle, such as standard passenger cars, sport utility vehicles, light trucks, heavy duty vehicles, minivans, buses, transit vehicles, bicycles, robots, farm implements, sports-related equipment or any other transportation apparatus.

FIG. 1 illustrates ICE 12 as defining a single cylinder 18 formed within engine block 13, for the purpose of clarity only, and is intended to additionally represent ICEs having a plurality of cylinders 18. Each cylinder 18 defines a combustion chamber 22, and the ICE 12 further includes an intake assembly 28 and an exhaust manifold 30, each in fluid communication with the combustion chamber 22 via intake passage 29 and exhaust passage 31, respectively. Intake passage 29 can be defined by intake assembly 28 and cylinder head 11. Similarly, exhaust passage 31 can be defined by exhaust manifold 30 and cylinder head 11. The ICE 12 includes a piston 20, configured for reciprocation within the cylinder 18. Combustion of an air/fuel mixture within the cylinder 18 reciprocates the piston 20 such that the piston can deliver tractive torque to one or more aspects of a vehicle (e.g., a wheel). Air can enter the combustion chamber 22 of the ICE 12 by passing through the intake assembly 28, where airflow from the intake manifold into the combustion chamber 22 is controlled by at least one intake valve 24. Fuel is injected into the combustion chamber 22 to mix with the air, or is inducted through the intake valve(s) 24, which provides an air/fuel mixture. The air/fuel mixture is ignited within the combustion chamber 22. Combustion of the air/fuel mixture creates exhaust gas, which exits the combustion chamber 22 and is drawn into the exhaust manifold 30. More specifically, airflow (exhaust flow) out of the combustion chamber 22 is controlled by at least one exhaust valve 26.

A TBC 16 can be applied to one of more components of the ICE 12 of vehicle 10, including the intake assembly 28, exhaust manifold 30, engine block 13, and cylinder head 11, among others. In one embodiment of the disclosure, the TBC 16 can be applied onto high temperature sections or components of the ICE 12 and bonded to the components to form an insulator configured to reduce heat transfer losses, increase efficiency, and increase exhaust gas temperature during operation of the ICE 12. In particular, the TBC 16 can be applied to one or more surfaces which define the intake passage 29, exhaust passage 31, and combustion chamber 22 to reduce or minimize heat losses and improve engine efficiency. It should be appreciated that the TBC 16 can be applied to components other than present within the ICE 12. More specifically, the TBC 16 can be applied to components of spacecraft, rockets, injection molds, and the like.

The TBC 16 is configured to provide low thermal conductivity and low heat capacity to increase engine efficiency. As such, the low thermal conductivity reduces heat transfer losses and the low heat capacity means that the surface of the TBC 16 tracks with the temperature of the gas during temperature swings and heating of cool air entering the cylinder is minimized. Additional description of the TBCs 16 referenced herein can be found in co-owned U.S. Pat. No. 1,0040,723 B2, the contents of which are herein incorporated by reference.

FIG. 2 illustrates a cross-sectional side view of a component 14 with a TBC 16 applied thereto. Component 14 includes a substrate 40 having at least one interior or presenting surface 42. Among other aspects, the TBC 16 comprises a thermal barrier material (TBM) such as hollow microspheres 50 which are aggregated against the surface 42 of the component 14. Upon initial aggregation of the hollow microspheres 50, voids 51 between the microspheres 50 occur. The hollow microspheres 50 inherently are low density (for example as relative to the component 14), and can be fashioned from various materials, such as those chosen to minimize thermal conductivity. The substrate 40 is a cast component, and, as described above, can comprise various components including the intake assembly 28, exhaust manifold 30, engine block 13, and cylinder head 11, among others. For example, in one embodiment, component 14 can comprise the intake assembly 28, and the interior surface 42 can define the intake passage 29. For example, in one embodiment, component 14 can comprise the engine block 13, and the interior surface 42 can define the cylinder 18 and side walls of the combustion chamber 22. For example, in one embodiment, component 14 can comprise the cylinder head 11, and the interior surface 42 can define the top surface of the combustion chamber 22.

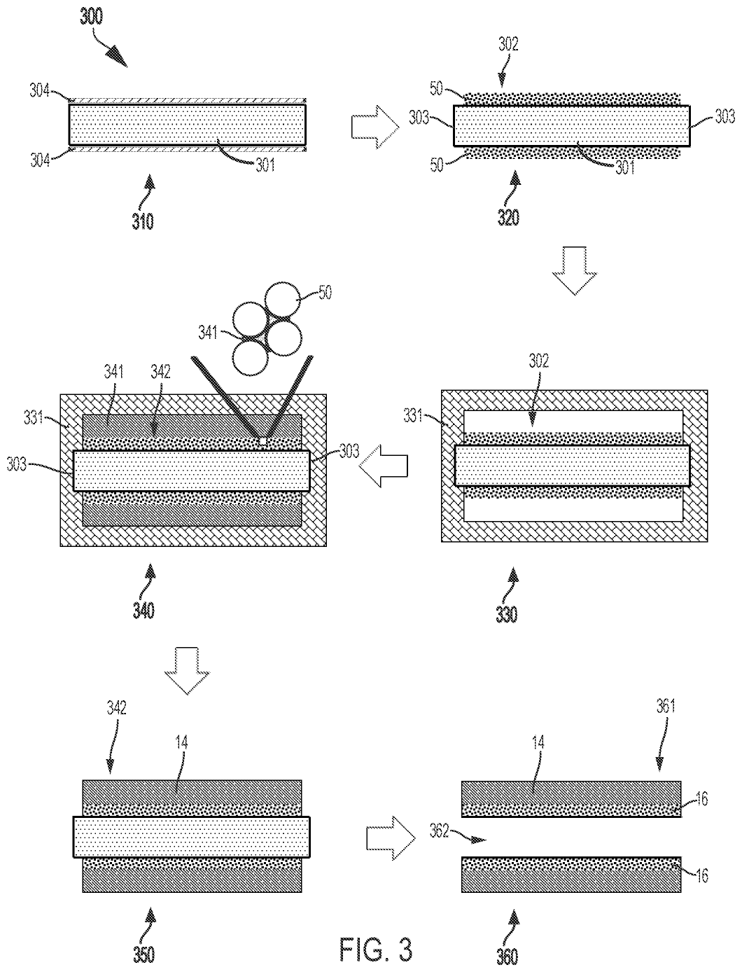

Applying the TBC 16 to a cast component 14 is difficult because the hollow microspheres 50 can be fragile, and are buoyant relative to a molten casting metal. Accordingly, FIG. 3 illustrates a block diagram of a method 300 for manufacturing a cast component 14 having a surface with a TBC 16 applied thereto. Method 300 comprises providing 310 a core 301, applying 320 a TBC 16 comprising a plurality of hollow microspheres 50 to the core 301 to form a coated core 302, disposing 330 the coated core 302 within a casting mold 331, casting 340 metal 341 around at least a portion of the coated core 302 to form a casting intermediary 342, and removing 360 the core 301 from the casting intermediary 342 to form a cast component 361. The cast component 361 can comprise an internal passage 362 which is at least partially covered with a TBC 16. Method 300 advantageously provides high adhesion of the TBC 16 to the cast component 14 due to the cast metal 341 impregnating the voids 51 between the microspheres 50 and/or otherwise forming bonds with the microspheres 50 (e.g., as facilitated by the casting 340 temperature of the metal 341). Further, method 300 allows for complex surface geometries to be coated with TBCs 16. Although FIG. 3 illustrates a straight core 301 and a resulting straight internal passage 362, it is to be understood that passage 362 can comprise any geometric configuration, including turns, and spirals, among others.

The plurality of microspheres 50 can comprise one or more materials, such as metal, glass, and/or ceramic materials, which are selected for to exhibit durability and resistance to oxidation, corrosion, and general degradation of structural integrity at high temperatures. Non-limiting examples of materials suitable for microspheres 50 include silicon oxide (e.g., SiO₂), aluminum oxide (e.g., Al₂O₃), yttria stabilized zirconia, and various metals including nickel, iron, tungsten, manganese, titanium, and alloys thereof, among others.

In a specific embodiment, microspheres 50 can comprise about 0 percent by weight to about 100 percent by weight of silicon oxide (SiO₂) and about 0 percent by weight to about 100 percent by weight of aluminum oxide (Al₂O₃). Alternatively, the plurality of ceramic microspheres can comprise about 50 percent by weight to about 70 percent by weight of silicon oxide and about 30 percent by weight to about 50 percent by weight of aluminum oxide to achieve a higher melting point.

The microspheres 50 can have an average diameter of between about 10 μm and about 100 μm and a shell thickness that is about 2% to about 10% of the diameter of the microsphere 50. Collectively, the microspheres 50 form a high porosity layer, for example which can have a porosity of at least about 75%, or a porosity of about 75% to about 95%. As used herein, “porosity” refers to the volume percent of air (or gaseous) relative to the total volume of a specimen (e.g., the TBC 16). The high porosity of the microspheres 50 defines a volume of air and/or gases contained within the TBC 16, thus providing the desired insulating properties of low effective thermal conductivity and low effective heat capacity. For example, the TBC 16 can exhibit a thermal conductivity of about 0.1 to about 0.6 W/m-K. In another example, the TBC 16 can exhibit a heat capacity of about 100 to 1000 kJ/m³-K. The thickness of the TBC 16 of the cast component 361 can vary depending on the component 14. For example, if the component 14 comprises a component integral to the combustion chamber 22, the TBC 16 have a thickness of about 50 μm to about 1,000 μm, although other thicknesses are practicable. In another embodiment, if the component 14 comprises a component integral to the exhaust manifold 30, the TBC 16 have a thickness of up to about 2.5 mm, or about 0.1 mm to about 2.0 mm, although other thicknesses are practicable. It is understood that various aspects of the TBC 16 (e.g., microsphere 50 material, microsphere 50 average diameter, microsphere 50 shell thickness, TBC thickness, etc.) can be tailored to meet the desired properties of a given cast component 361.

The TBC 16 can further optionally comprise a binder and/or one or more particles to facilitate the application 320 of the TBC 16 to the core 301. The binder can include one or more materials including water soluble binders, such as hydroxy-propyl cellulose, polyvinyl-alcohol, polyvinyl-pyrrolidone or cellulose polymer derivatives, sintering aids, such as boron trioxide, and resins, such as polyvinyl butyral resin. Binders can be used in concentrations of about 0.1% by weight to about 8% by weight, for example, although other ranges can be suitable. The binder can be mostly removed during the subsequent heat treatments. An organic solvent such as isopropanol or acetone can also be added to water or fully substituted for the solvent in which case the binder must be suitably soluble in the mixture.

The particles can comprise material(s) that melt or sinter at a lower temperature than the microspheres 50 to fuse adjacent microspheres 50 together and with the surface 42 of the substrate 40 without deforming or damaging the microspheres 50. The particles can comprise ceramic or glass, such as frit, boron trioxide, aluminum oxide, aluminum silicate, silica, silicate glass or mixtures thereof which have a lower melting point than the hollow spheres and promote sintering and bonding. Additionally or alternatively, the particles can comprise a low melting point metal, such as copper or zinc. Additionally or alternatively, the particles can comprise a metal, such as Aluminum or an aluminum alloy, which melts at a temperature below 660° C. to fuse the microspheres 50 and convert by oxidation to an aluminum oxide. Additionally or alternatively, the particles can comprise a metal nitrate or metal alkoxide precursor, such as aluminum nitrate or titanium isopropoxide or tetraethyl orthosilicate, that can be pyrolyzed to an oxide, for example aluminum oxide or titanium oxide or silicon oxide. In this embodiment, microspheres 50 are mixed with a solution of the metal nitrate or alkoxide precursor or with the pure precursor. Additionally or alternatively, the particles can comprise a preceramic polymer such as siloxanes, silanes, carbosilanes, silazanes, borosilanes and similar molecules that are pyrolyzed to an oxide.

Applying 320 the TBC 16 to the core 301 can comprise packing the TBC 16 against the core 301, spraying the TBC 16 onto the core 301, or dipping the core 301 in TBC 16. For example, microspheres 50 can be packed against the core 301 while the core 301 is positioned within a preliminary mold (not shown) to form the TBC. The microspheres can also be present within a slurry which is sprayed onto the core 301, or into which the core 301 is dipped. The slurry can include, as a powder finer than the size of microspheres 50, additives to facilitate sintering via chemical reaction, diffusion, or alloying, and the rheology can be adjusted by addition of appropriate amount of solvent, binders, lubricants, coagulants, and/or antiflocculants to minimize and/or remove carbonaceous or other contaminants left over which can affect with a sintering process or the final coating composition. The slurry can further include a solvent, such as water, and a solvent-soluble binder, such as those described above. Other slurry additives, for example polyethylene-glycol and glycerol, can be used for rheological adjustments such as deflocculation, lubrication, and antifoaming to maximize the packing efficiency upon slurry application.

Applying 320 the TBC 16 to the core 301 can further comprise sintering or otherwise solidifying (e.g., curing) the TBC 16, wherein sintering and/or curing techniques are utilized depending on the composition of the TBC 16. For example, a TBC 16 can be sintered at temperatures of about 700° C. to about 1000° C., although other temperatures are practicable. Curing typically occurs at temperatures high enough to drive off the solvent (e.g., water), such as at temperatures of about 80° C. to about 130° C., although other temperatures are practicable. In some embodiments, after the solvent is evaporated, the monomer/microsphere 50 coating is then cured, either by UV light exposure or by thermal annealing. The curing crosslinks the monomers and forms a rigid polymer matrix. The polymer matrix can additionally be pyrolyzed in air or inert atmosphere to form a ceramic.

The core 301 is suitably fabricated from materials configured to both withstand the conditions of method 300 (e.g., high temperatures) and facilitate the removal thereof from the casting intermediary 342. The core 301 can comprise various materials known in the art, including salt-based materials, and filler-binder systems that utilize a high-stability and generally inert filler with a binder. The core 301 can be fabricated by any technique suitable for the particular material(s) constituting the core. For example, the core can be formed in a core machine (e.g., a cold box core machine, a hot box core machine), core blown, injection molded, die-casted, or 3-D printed, among other fabrication techniques.

Regarding filler-binder systems, the fillers can comprise sand, ceramics (e.g., Al₂O₃, SiO₂, TiO₂, Fe₂O₃), carbides (e.g., tungsten carbide, silicon carbide), nesosilicates and/or orthosilicates (e.g., ZrSiO₄, Al₆Si₂O₁₃), spinel group materials (e.g., FeCr₂O₄), carbon-based materials (e.g., graphite), among others, and combinations thereof. The fillers typically comprise a substantial portion of the core 301 (e.g., at least about 90%, at least about 95%, or at least about 98% filler). Binders can comprise silicate-based materials, or “water glass” materials, for example. In some embodiments polymeric binders can be used. Silicate-based binders can be formed from alkali silicates, and are typically combined with the filler and subsequently sintered to form the core 301. In one example, silicate-based binders can be formed from sodium silicate and sodium hydroxide. In another example, silicate-based binders can be formed from barium sulfate, silica, and graphite. In another example, silicate-based binders can be formed from sodium silicate and potassium silicate. Silicate-based binders are typically water soluble, and can be removed with water. In some instances, the water-solubility of silicate-based binders diminishes during sintering or other heat treatments, and therefore the core 301 must be mechanically removed 360 from the casting intermediary 342. Mechanical removal methods can comprise removal by drilling, grinding, shaking, or other means as are known by those of skill in the art. Removal means should be tailored to remove 360 the core 301 from the casting intermediary 342 without damaging or disrupting the TBC 16.

Salt-based cores 301 generally contain at least 80%, at least 90%, or at least 95% salt by weight. Salt-based materials suitable for constructing the core 301 can include sodium carbonate, potassium chloride, and sodium chloride, potassium carbonate, sodium bromide, potassium bromide, sodium iodide, potassium iodide, calcium chloride, potassium nitrate, sodium nitrate, potassium sulfate, lithium sulfate, magnesium sulfate, sodium sulfate, barium carbonate, calcium carbonate, and combinations thereof. Typically, the one or more salts are melted, and then solidified (e.g., die-cast) into a desired form. The salt-based core 301 can further optionally comprise a reinforcing agent, such as a ceramic material contained in the mixture of one or more salts. Such salt-based materials exhibit high melting temperatures, rendering them suitable for the high temperature sintering and casting 340 steps of method 300. Further, the salt-based cores 301 are water soluble, and therefore can be removed 360 via water (e.g., via a water wash, spray or soak). The salt-based cores can additionally or alternatively be removed by mechanical means, such as by those described above.

In order to facilitate removal 360 of the core 301 from the casting intermediary 342, the TBC 16 can be applied 320 to the core 301 such that at least one region 303 of the core remains exposed. In some embodiments, and as illustrated in FIG. 3, the TBC 16 can be applied 320 to the core 301 such that a plurality of regions 303 of the core remain exposed. Similarly, in some embodiments, the coated core 302 can be disposed within the casting mold 331 such that at least a portion of each of the one or more exposed regions 303 are not covered with cast metal 341.

In an alternative embodiment of method 300, the core 301 can be formed as described above, and further comprise a metal layer 304 applied to thereto. For example, the outer metal layer 304 can comprise nickel electroplated to the core 301. Although the outer metal layer 304 is illustrated in step 310 of FIG. 3 and omitted in subsequent steps for the sake of clarity, it is to be understood that the metal layer 304 can form an integral element of the core 301 in any step of method 300. For example, the TBC 16 can be applied 320 to the outer metal layer 304. In such embodiments, wherein the core 301 comprises an outer metal layer 304, the core 301 can be removed 360 at any point subsequent to providing the core 301 (e.g., prior to applying 320 the TBC 16 to the core 301, prior to disposing 330 the coated core 302 in the casting mold 331, etc.)

Casting 340 metal 341 around at least a portion of the coated core 302 to form a casting intermediary 342 can comprise providing a molten metal 341 within the casting mold 331 such that the molten metal at least partially covers the coated core 302. Providing a molten metal 341 can include filling the casting mold 331 or disposing a stock of metal 341 within the casting mold 331 and heating the metal 341 to achieve a desired casting condition of the metal 341. Casting 340 can further comprise solidifying the metal 341. Casting can occur at temperatures of about 600° C. to about 800° C., depending on the type of metal 341 being cast. For example, casting an aluminum alloy can occur at about 720° C., in some embodiments. The casting intermediary 342 formed accordingly comprises the coated core 302 at least partially imbedded in the solidified metal 341, and optionally further includes the casting mold 331. Method 300 can optionally comprise removing 350 the casting intermediary 342 from the casting mold 331. Removing 350 the casting intermediary 342 from the casting mold 331 generally occurs after the metal 341 has solidified. The casting intermediary 342 can be removed 350 from the casting mold 331 prior to, subsequent to, or while the core 301 is removed 360 from the casting intermediary 342. In some embodiments the casting mold 331 remains an integral part of the cast component 361. In other embodiments, the casting mold 331 comprises a sand mold.

In a specific embodiment, component 14 comprises an exhaust manifold 30. The core 301 comprises a 3D-printed soluble polymeric material with a nickel outer metal layer 304, and the TBC 16 comprises nickel microspheres 50 sprayed onto the nickel outer metal layer 304 and sintered. The TBC 16 further comprises a ceramic layer applied to the nickel microspheres 50 as a ceramic slurry which is cured to form a hard shell coating. The nickel outer metal layer 304 comprises a thickness of about 0.075 mm to about 0.125 mm, the nickel microsphere 50 layer comprises a thickness of about 0.2 mm to about 0.4 mm, and the ceramic hard shell coating comprises a thickness of about 0.5 mm to about 0.7 mm, thereby providing a TBC 16 with a thickness of about 0.775 mm to about 1.225 mm. In such an embodiment, the TBC 16 can comprise a polymeric binder.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that cannot be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for manufacturing a cast component having a surface with a thermal barrier coating (TBC) applied thereto, the method comprising:
providing a core;
applying the TBC to the core to form a coated core, wherein the TBC comprises a plurality of hollow microspheres;
disposing the coated core within a casting mold;
casting metal around at least a portion of the coated core to form a casting intermediary; and
removing the core from the casting intermediary to form a cast component.

2. The method of claim 1, further comprising removing the casting intermediary from the casting mold.

3. The method of claim 1, wherein the TBC is applied to the core such one or more regions of the core remains exposed.

4. The method of claim 3, wherein the coated core is disposed within the casting mold such that at least a portion of each of the one or more exposed regions of the core are not covered with cast metal.

5. The method of claim 1, wherein the core comprises a binder and one or more fillers.

6. The method of claim 5, wherein the binder comprises a silicate-based material.

7. The method of claim 6, wherein the core is removed mechanically.

8. The method of claim 1, wherein the core comprises a salt-based material.

9. The method of claim 8, wherein the core is removed via water.

10. The method of claim 1, wherein the hollow microspheres have an average diameter of about 10 μm to about 100 μm.

11. The method of claim 1, wherein the TBC has a porosity of at least about 75%.

12. The method of claim 1, wherein the hollow microspheres comprise a metal, glass, and/or ceramic material.

13. The method of claim 1, wherein the hollow microspheres comprise a shell thickness of about 2% to about 10% of the diameter of the microsphere.

14. The method of claim 1, wherein the core further comprises an outer metal layer.

15. The method of claim 1, wherein applying the TBC to the core further comprises sintering or otherwise solidifying the TBC.

16. The method of claim 1, wherein the TBC further comprises a binder, and applying the TBC to the core comprises applying the TBC directly to the core.

17. The method of claim 16, wherein applying the TBC to the core further comprises curing the TBC.

18. A method for manufacturing a cast automotive component having an internal passage with a thermal barrier coating (TBC) applied to a surface thereof, the method comprising:
providing a core;
applying the TBC to the core to form a coated core, wherein the TBC comprises a plurality of hollow microspheres;
disposing the coated core within a casting mold;
casting metal around at least a portion of the coated core to form a casting intermediary; and
removing the core from the casting intermediary to form a cast component.

19. The method of claim 18, wherein the automotive component comprises an engine intake assembly, an engine exhaust manifold, an engine block, and/or an engine cylinder head.

20. The method of claim 19, wherein the surface of the cast automotive component comprises one or more surfaces which define an engine intake passage, an engine exhaust passage, and an engine combustion chamber.
